(19) United States
(12) Patent Application Publication
(10) Pub. No.: US 2015/0371261 A1
(43) Pub. Date: Dec. 24, 2015

(54) Comment Generator for Vehicles

(71) Applicant: Pure Auto LLC dba PureCars, Charleston, SC (US)

(72) Inventors: Jeremy Anspach, Charleston, SC (US); Jason Kuykendall, Fishers, IN (US)

(73) Assignee: PURE AUTO LLC DBA PURECARS, Charleston, SC (US)

(21) Appl. No.: 14/312,178

(22) Filed: Jun. 23, 2014

(51) Int. Cl. G06Q 30/02; G06Q 30/06

(52) U.S. Cl. CPC G06Q 30/0253; G06Q 30/0256; G06Q 30/0625

(57) ABSTRACT

A media content generator for vehicles. By standardizing information from a variety of sources, the present invention is able to analyze whether a particular vehicle has certain features. The positive features are ranked and categorized into vehicle highlights. Once the vehicles highlights are known, media content is automatically built for the particular vehicle. Media segments relevant to the present highlights are included in the content, while absent features are ignored.

### FIELD

The present invention relates to computer-implemented inventions in the retail automotive industry.

### BACKGROUND

Vehicle shopping is often a stressful and complicated process. Consumers want to educate themselves, but even in today's information age specific details about car dealership inventory offered for sale are lacking. Historically, dealers do a very poor job of communicating value, especially in their pre-owned vehicle inventory. This is partly due to dealers not being digitally savvy and partly due to dealerships typically only being experts in one type of vehicle—when a Ford dealership obtains a Toyota as a trade-in, the dealership may not be familiar with the value proposition of the Toyota.

A knowledgeable and dedicated consumer can potentially access multiple sources of information to learn about specific vehicles being offered for sale, but the sources are disparate and looking up multiple vehicles is time-consuming. It would be almost impossible for even a reasonably diligent consumer to access all relevant information on all vehicles available in the market.

There are continuing efforts to improve the vehicle buying experience.

### BRIEF DESCRIPTION OF THE DRAWINGS

Various embodiments of the invention are disclosed in the following detailed description and the accompanying drawings:

FIG. 1 illustrates an exemplary environment where vehicle comments can be generated.

FIG. 2A illustrates an exemplary process by which a value engine directly delivers relevant information to the user's device.

FIG. 2B illustrates an exemplary process by which a value engine indirectly delivers relevant information to the user's device.

FIG. 3 illustrates an exemplary network topology where the value engine interacts with multiple sources through the use of network(s).

FIG. 4 is an exemplary illustration of architecture of a comment engine.

FIG. 5 is an exemplary comment built with conditional segments, non-conditional segments, and variables.

FIG. 6 illustrates the exemplary architecture of the typical computing device that would interact with the exemplary environment and exemplary architecture of the device.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise explicitly provided for in the claims.

Detailed embodiments of the present invention are disclosed herein; however, it is to be understood that the disclosed embodiments are merely exemplary of the invention that may be embodied in various forms. A person of ordinary skill will appreciate from the description herein that modifications can be made to the described embodiments and therefore that the specification is broader in scope than the described embodiments. All examples are therefore non-limiting. The figures are not necessarily to scale, and some features may be exaggerated to show details of particular components. Therefore, specific structural and functional details disclosed herein are not to be interpreted as limiting, but merely as a basis for the claims and as a representative basis for teaching one skilled in the art to variously employ the present invention.

In some examples, the described techniques may be implemented as a computer program or application or as a plug-in, module, or sub-component of another application. The described techniques may be implemented as software, hardware, firmware, circuitry, or a combination thereof. If implemented as software, the described techniques may be implemented using various types of programming, development, scripting, formatting languages, frameworks, syntax, applications, protocols, objects, runtime environments, virtual machines, or techniques. The described techniques may be varied and are not limited to the examples or descriptions provided.

Wherever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially,” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c.

As used herein, “device” indicates a piece of computer hardware that alone or in combination with other computer hardware can execute program code. Examples of computer hardware include, but are not limited to, processors; memory; storage; output devices including visual interfaces such as for example, screens and touch screens; and input devices such as, for example, keyboards, pointing devices such as computer mouses (mice), buttons, touch screens, touch pads, and microphones.

As used herein, “seller” refers to any person or entity offering one or more vehicles for purchase, whether wholesale, fleet, or retail. A seller can be a manufacturer, importer, wholesale distributor, car dealership, or individual.

As used herein, “vehicle” refers to any machine designed to transport people or freight. Automobiles, motorcycles, scooters, limousines, sport-utility vehicles, vans, minivans, trucks, minibuses, buses, recreational vehicles, and tractor-trailers may be mentioned as examples of automotive vehicles. Thus, embodiments of the present invention may relate to automotive sales, while other embodiments relate to motorcycle sales, while still other embodiments related to all vehicular sales. Embodiments described for automotive sales are equally applicable to embodiments for other types of vehicle sales.

As used herein, a “vehicle edition” is a vehicle's make, model and year (and sometimes body style and trim) and generally describes a class of vehicles. For example, all 2013 MAZDA3 i compact cars with the SV level trim have a factory-installed 148-hp, 5-speed engine, while all 2013 MAZDA3 i compact cars with a Sport level trim have a factory-installed 155-hp, 6-speed engine, with cruise control, remote keyless entry and a USB audio input port.

As used herein, a “particular vehicle” is single, identifiable vehicle as opposed to a vehicle edition. For example, if Mrs. Jones were trying to sell her 2011 Chrysler Town & Country minivan, it would have a unique vehicle identification number (VIN), a specific number of miles, certain factory-installed and dealer-installed options, a certain accident history, an advertised price, and perhaps a grape soda stain in the back seat. Once Mrs. Jones sold her minivan, the ownership of that particular vehicle would pass to the buyer. Although the phrase ‘particular vehicle’ will always mean a single, identifiable vehicle, the absence of the word ‘particular’ does not necessarily mean a particular vehicle is not being discussed. Those skilled in the art will recognize from the context of the relevant text when the word ‘vehicle’ is a reference to a particular vehicle, when it is a reference to a vehicle edition, and when it is a reference to more generally.

As used herein, “template” refers to a data structure designed to organize certain data. For example, digital vehicle inventory data may be stored differently from one seller to the next. A template will receive that data and organize it into a record that is readable by the various modules of the several embodiments of the present invention. In some cases, for example, the digital vehicle inventory data for a particular vehicle can be organized by template into a record uniquely identified by the vehicle's VIN, and include one or more other fields, whether each field is populated or not, that describe the particular vehicle's features. In other exemplary cases, the already-organized particular vehicle data might be further organized by a template to display only certain data sub-sets (e.g., top features of populated data) to a potential buyer.

As used herein, “electronic communication” refers to the ability of one module, component, device, or system to send to or receive data from another module, component, device, or system. Electronic communication can be provided by any suitable means. In some cases, electronic communication occurs within a chip, across a motherboard, by cable, wirelessly, via the internet, or a combination of the foregoing.

The definitions of other words will be apparent to those skilled in the art from the context in which they are presented.

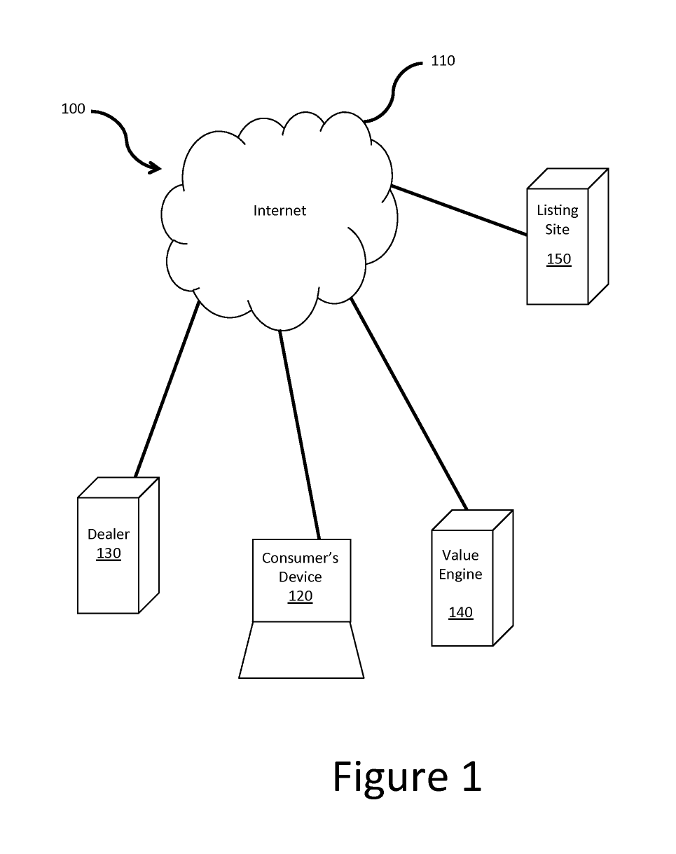

FIG. 1 illustrates an exemplary environment where vehicle comments can be generated. The environment 100 includes the Internet 110, which is a system of interconnected computer networks that allows multiple devices to communicate with each other in order to provide users with information or data. Although the Internet 110 is a widely used technology, other networks may be used in connection with the environment 100. A user connects to the Internet 110 through the use of a personal device 120 (e.g., phone, tablet, desktop computer, laptop computer, or mobile device) and communicates through the Internet 110 to the dealer 130 website. Intermediary networks (e.g., LAN or WAN) may connect the various devices 120-150 to the Internet 110. Dealer 130 has an inventory of vehicles that are currently being offered for sale. Once the user's device 120 is connected with the dealer 130, and a specific vehicle is selected, the value engine 140 is engaged in order to deliver relevant information to the user's device 120.

The value engine 140 can additionally or alternatively be engaged with third party listing sites 150. In such a situation, the consumer's device 120 would engage with a listing site 150 (such as cars.com®, autotrader.com®, or lemonfree.com®) that aggregates inventory from many dealers. Content on the listing site 150 would typically have been pre-generated by the value engine 140 prior to the consumer 120 accessing information on any specific vehicles in the dealer 130 inventory.

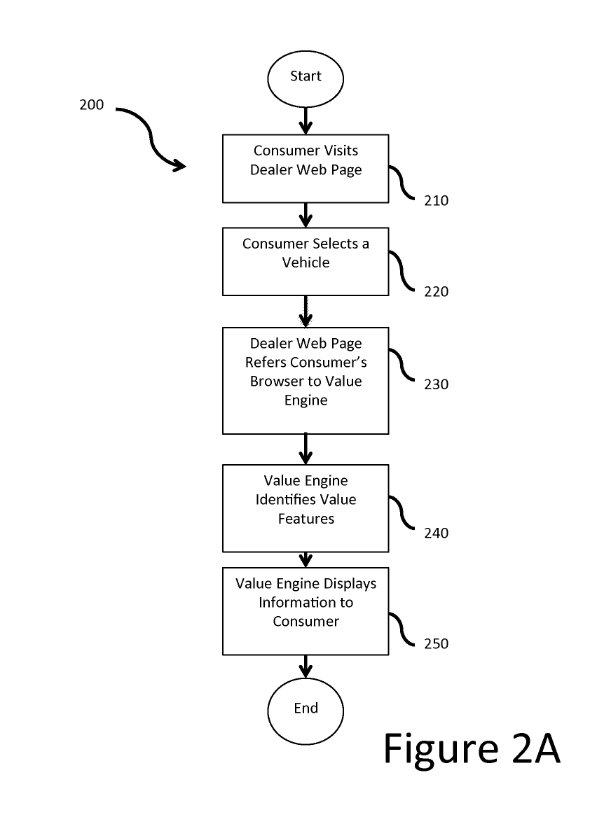

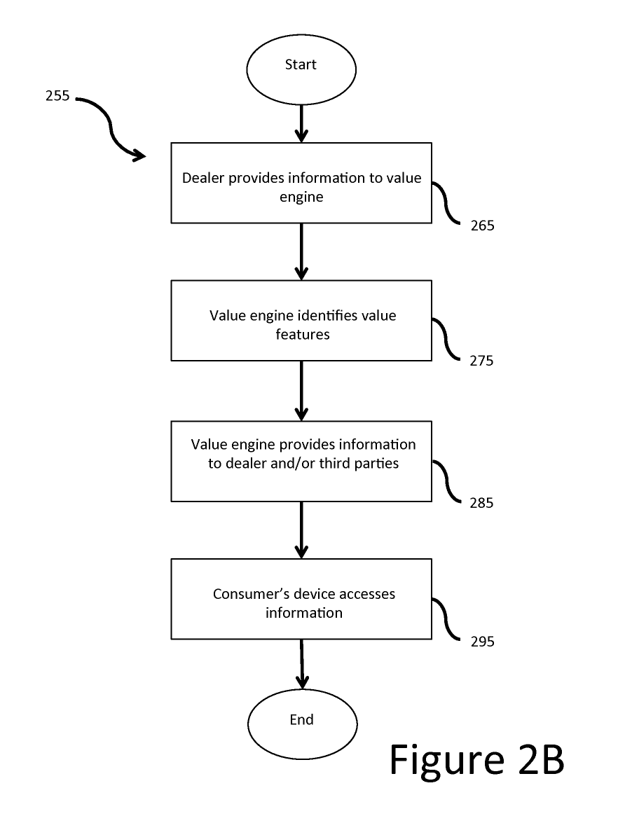

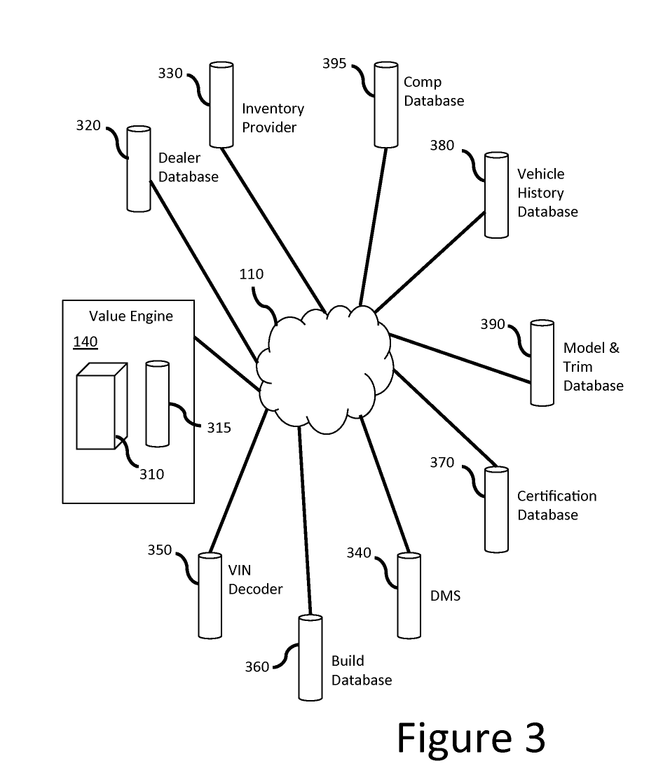

FIG. 2A illustrates an exemplary process 200 by which the value engine 140 directly delivers relevant information to the user's device 120. The user starts the process by using the Internet 110 to visit a dealer 130 webpage in step 210. In step 220 the consumer can select a particular vehicle from among the several vehicles that are typically available on a dealer 130 webpage. Once a particular vehicle is selected, the dealer 130 webpage refers the consumer's device 120 to the value engine 140 in step 230. The dealer 130 webpage passes information to the value engine 140 in order to uniquely identify the selected vehicle. A VIN is typically used for motor vehicles, towed vehicles, motorcycles, scooters and mopeds while a hull identification number (HIN) is typically used for boats. Although having the dealer 130 webpage pass the VIN to the value engine 140 may be the most direct way for the value engine to obtain the VIN, other mechanisms may be available, as is described below in connection with FIG. 3.

In step 240 the value engine 140 performs functions in order to identify value features in the selected vehicle. Value features are described in more particularity below and can include information from an inventory provider, a dealer, a VIN decoder, a build database, a dealer management system, a certification database, a vehicle history database, a model & trim database, and a comp database. In step 250 the value engine 140 displays the information to the consumer.

Although consumer's device 120 receives information directly from the value engine 140, the action may be invisible to the consumer. For example, the reference may be an embedded image that the consumer perceives as part of the dealer 130 webpage, but is, in actuality, derived from the value engine 140. Alternatively, the action in step 230 may cause the consumer's device 120 to browse away from the dealer's page displaying the particular vehicle and onto a different page generated by the value engine 140.

FIG. 2B illustrates an exemplary process 255 by which the value engine 140 indirectly delivers relevant information to the user's device 120. In the alternative process the dealer 130 provides information about its inventory of particular vehicles for sale to value engine 140 in step 265. The dealer 130 can either push information to the value engine 140, or the value engine 140 can pull information from a file or files hosted by the dealer 130. Then, in step 275, the value engine 140 identifies the value features in all the particular vehicles that were provided in step 265. In step 285, the value engine 140 output is delivered to the dealer 130, or to listing sites 150, or both. In step 295, the consumer's device 120 is then able to access the generated information from the dealer 130 or the listing sites 150 at any time after the output delivery.

FIG. 3 illustrates an exemplary network topology where the value engine 140 interacts with multiple sources through the use of network(s), such as the Internet 110. During communication, the value engine 140, comprised of a value engine server 310 and value engine storage or database component 315, contacts external servers and databases to perform the function of identifying value features, as described in step 240 in FIG. 2A and step 275 in FIG. 2B. The value engine 140 gathers information from multiple sources that can include: a dealer database 320, an inventory provider 330, a dealer management system 340, a VIN decoder 350, a build database 360, a certification database 370, a vehicle history database 380, a model & trim database 390, and a comp database 395.

In most cases, the value engine 140 must pass certain information in order to receive relevant information from the source, although some sources may be set up to allow the value engine 140 to periodically access all records, not just those for the particular vehicles being requested. Although a source may be represented as single database for ease of understanding, those skilled in the art will appreciate that multiple databases from multiple parties might be accessed to receive relevant data. Similarly, a single source might, in actuality, host several different informational sources. Furthermore, templates are often necessary to organize the data from the source into the value engine database 315. Certain databases will be standardized such that a single template can be used, while other databases will be highly individualized, requiring a more flexible approach. As one example, certain databases may use the terms sunroof and moonroof interchangeably or incorrectly. Accordingly, a template will preferably recognize and standardize terms. As another example, one service databases might label “Lube, Oil & Filter” service with the op code “LOF” while another service database might identify the same service with the op code “FOL.” In one exemplary embodiment of the invention, a template (or multiple templates) would translate the LOF op code from the first database and the FOL op code from the second database into a standard “Oil Changed” in the value engine database 315.

The dealer database 320 can both host the dealer 130 webpage and may additionally provide additional information regarding the dealerships practices, contact information, warranties, or specific information about the particular vehicles for sale. In one embodiment, the dealer database 320 merely passes the selected vehicle's unique identifier and dealer-specific information is already stored in the value engine database 315 or obtained from other sources.

The inventory provider 330 provides the value engine 140 with vehicle information of vehicles available for sale. Such vehicle information can be stored by VIN or stock number, and would typically include pictures associated with the vehicle, current asking price, mileage and other vehicle details. As with most sources, the value engine 140 could either store the vehicle information in the value engine database component 315 or query the inventory provider 330 when information is required. If the information is stored in the value engine database component 315, the information could be updated either as information is updated (i.e., when the price of a car changes, when a new car is listed, or when a car is sold) or replaced periodically with the dealer's latest inventory.

The dealer management system (DMS) 340 is a database of service information that is operated by dealers and any information entered to the system is done onsite at the dealership. The DMS may indicate maintenance or repairs to existing vehicles from new tires to new transmissions. The DMS itself may not be equipped to handle queries from the value engine 140, so an intermediary may be required to process queries. The intermediary may simply be a partial mirror of the DMS, containing only service information from vehicles currently being offered for sale and excluding the service information for vehicles not currently owned by the dealership (i.e., the dealership's current service department customers). The intermediary may further limit the subset by including only particular services (e.g., new tires and new brakes, but not body repair) or particular date ranges. Whether an intermediary is used, and whether the intermediary is provided by a third party, the dealer 130 or as part of the value engine 140 will depend on the specific details of the environment 100. Similarly, whether the dealer database 320, the inventory provider 330 and DMS 340 are all provided by a single source will also depend on the environment 100.

The VIN decoder 350 is a database that decodes the unique number given to each vehicle consisting of seventeen (17) digits. The decoder uses the unique number to identify vehicle specific qualities such as what country the car was manufactured in, the model of the car, the plant where the car was manufactured, and vehicle specific attributes, such as engine type.

The build database 360 provides even more specific information related to a VIN number. When a vehicle manufacturer builds a particular vehicle, it leaves the factory with certain installed options. The manufacturer maintains a record of such options specific to the particular vehicle, often along with other relevant data, such as recalls and recommended maintenance schedules.

The certification database 370 will confirm whether a particular vehicle is certified. There are several ways used vehicle can be certified. Most car manufacturers have programs that certify pre-owned cars, dealers often offer certification/warranty programs, and independent third parties such as Motor Trend® also have certification programs. If certification information is not passed to the value engine 140 through the one of the other sources (e.g., inventory provider 330, dealer database 320, or DMS 340) the certification database 370 can provide certification information. There may be multiple certification databases 370, and the value engine 140 may only selectively check a particular certification database 370. For example, there would be no reason to check a Hyundai certification database for a Ford Focus. Similarly, if only certain dealers participated in the Motor Trend® program, it might be efficient to only check particular vehicles from those participating dealerships against the Motor Trend® certification database.

The vehicle accident and history database 380 tells the value engine 140 whether a particular vehicle has been in accidents, subject to warranty repairs, or other information (e.g., whether the vehicle had multiple previous owners) that could make the particular vehicle less valuable to a potential buyer 120. A single third party source (like Carfax®) might be able to provide all such information, or multiple third party databases may need to be consulted.

Unlike the other sources previously discussed, the model & trim database 390 does not contain information about a particular vehicle but contains information about vehicles editions. In many situations, multiple third party databases would be consulted for various pieces of information. For example, Consumer Reports® may have reliability information for a make, model and year. Cars.com® might have user reviews for a make and model. Chrome® might have trim-level detail about standard equipment for each make, model and year. Motor Trend® might have ranking information for a make, model and year. NADA® might provide pricing information for make, model, year and trim when additional details are provided, such as mileage, condition and options. The comp database 395 is a repository of vehicles on the market so that comparative vehicles could be evaluated. If the selected specific vehicle is, for example, a 2008 Audi A8 Quattro with 60,000 miles, then the comp database 395 could be queried for other vehicle editions (i.e., 2008 Audi A8 Quattros) currently for sale in a similar geographical region with a similar mileage. The comp database 395 could be used to identify comparative vehicles to the consumer and/or it could be used to generate a market average price. The comp database may simply be an aggregate of inventory provider 330 information from multiple dealerships, or it may include vehicles listed for sale on various third party websites or listing sites 150.

In a preferred embodiment, the value engine 140 uses the information gathered through the Internet 110 from all or some of the listed sources and evaluates the information in order to present the information to the consumer 120. Often, the information is ranked and filtered so that only value attributes (“highlights”) are presented. For example, if a car does not have a moon roof or was not recently serviced, such information would typically not be a value attribute. Only if a particular value attribute actually applies to a particular vehicle, would a highlight be listed. Accordingly, if a vehicle were not priced below the market average (i.e., it is a higher than average price), then price comparisons to market would be absent in such a preferred embodiment.

It may be useful to categorize the various value features. For example, “reconditioning” highlights may include: 1 year/15 k mile complimentary maintenance [7], new tires [8], new brakes [9], new front brakes [10], new rear brakes [11], lifetime engine guarantee [12], lifetime transmission guarantee [13], 15 k service performed [14], 30 k service performed [15], 30 k/60 k service performed [16], 60 k service performed [17], timing belt replaced [18], new battery [29], brake system flushed [30], engine belts replaced [31], wheel alignment completed [32], tires rotated & balanced [33], tires balanced [34], tires rotated [35], oil changed [36], new engine air filter [37], new cabin air filter [38], new wiper blades [39], transmission serviced [40], coolant flushed [41], AC system serviced [42], engine serviced [43], gold star complete dealer inspection [44], multi-point inspection [45], 125 point inspection [46], state inspection completed [47], emission inspected [48], brake inspection [49], vehicle detailed [50], full detail [51], and power steering flush [52]. It should be appreciated that some of the reconditioning value features are redundant and use of one would exclude use of another. For example, “tires rotated & balanced” would never appear with both “tires rotated” and “tires balanced.” Additionally, in those embodiments where it is useful to order and rank the reconditioning value features, the above order is one example of a ranking, where new tires is the most desirable feature and power steering flush is the least desirable. The number in the square bracket next to each feature will be explained below.

Similarly, “Option” highlights might include: navigation system [19], backup camera [20], Bluetooth [21], entertainment system [22], heated front seats [23], cooled front seats [24], heated rear seats [25], cooled rear seats [26], leather seats [27], 3^{rd} row seating [28], satellite radio [66], iPod adapter [67], panoramic sunroof [68], dual sunroofs [69], sunroof/moonroof [70], remote engine start [71], rear bucket seats [72], chrome wheels [73], high output engine [74], turbocharged engine [75], supercharged engine [76], 12 cylinder engine [77], 10 cylinder engine [78], 8 cylinder engine [79], 6 cylinder engine [80], flex fuel engine [81], rotary engine [82], electric hybrid engine [83], plug-in electric engine [84], electric engine [85], plug-in electric flex fuel [86], plug-in electric gas engine [87], flex fuel electric hybrid [88], propane engine [89], natural gas engine [90], diesel engine [91], CVT auto trans [92], night vision [93], heads-up display [94], parking sensors [95], premium sound system [96], all wheel drive [97], hard top convertible [98], soft top convertible [99], T-top roof [100], targa roof [101], high intensity headlights [102], 4-wheel drive [103], active suspension [104], HD radio [105], DVD player [106], MP3 CD player [107], multi-disc changer [108], hard drive media storage [109], keyless start [110], rain sensing wipers [111], power liftgate [112], power running boards [113], all wheel steering [114], cruise control [115], multi-zone air conditioning [116], rear air conditioning [117], bedliner [118], aux. audio input [119], automatic headlights [120], tire pressure monitor [121], keyless entry [122], trunk release remote [123], front wheel drive [124], rear wheel drive [125], security system [126], telematics system [127], fog lights [128], air suspension [129], stability control [130], traction control [131], ABS brakes [132], brake assist [133], auto climate control [134], power sliding rear door [135], rear seat pass through [136], wood trim [137], leather steering wheel [138], synthetic leather seats [139], front bucket seats [140], lumbar support [141], power seat [142], seat memory [143], auto dimming rearview mirror [144], garage door opener [145], mirror memory [146], power windows [147], power locks [148], power folding mirrors [149], power mirrors [150], heated mirrors [151], running boards [152], power steering [153], rollover protection bars [154], rear spoiler [155], roof rack [156], bed canopy [157], bed tonneau cover [158], cargo shade [159], tow hitch [160], stepside pickup box [161], rear sliding window [162], rear sliding door [163], front split bench seats [164], rear bench seats [165], front bench seats [166], trip computer [167], CD player [168], rear seat audio controls [169], AM/FM radio [170], telephone installed [171], and telephone pre-wired [172]. In those embodiments where it is useful to order and rank the option value features, the above order is one example of a ranking.

Certain other highlights might be characterized in a catch-all “Other” category, or may not be categorized at all, and might include: priced below average [1], Motor Trend certified [2], certified vehicle [3], CARFAX 1-owner [4], low miles [5], fuel efficient [6], in demand color [53], new arrival [54], late model year [55], ALG best residual value [56], JD power quality award [57], IIHS top safety pick [58], JD power APPEAL award [59], Ward's 10 best engines [60], Motor Trend SUV award [61], Car and Driver 10 best [62], Motor Trend truck award [63], Motor Trend car award [64], and NHTSA 5-star rating [65]. In those embodiments where it is useful to order and rank the other value features, the above order is one example of a ranking.

The various reconditioning, option and other value features may also be ranked and ordered against each other. Although an entire category might be ranked above another category, more specific rankings are possible. For example, the numbers in [square brackets] next to each highlight in the above paragraphs could represent one possible global ranking system so that priced below average is the highest rated feature while telephone pre-wired is the lowest rated feature. The exemplary ranking is capable of many modifications, and, in certain embodiments, may be customizable by the dealer.

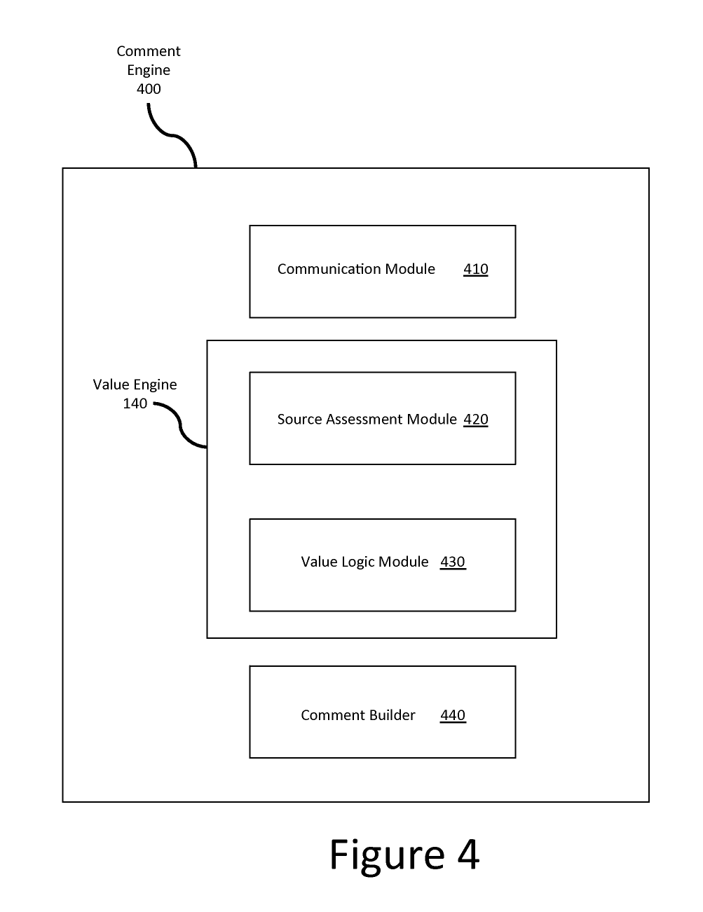

FIG. 4 is an exemplary illustration of architecture of a comment engine 400. The comment engine 400 has a communications module 410, a source assessment module 420, a value logic module 430 and a comment builder 440. All of these components are used in combination to show the consumer a preferred vehicle by displaying the information on the dealer's 130 webpage while the consumer is shopping for automobiles while using the Internet 110.

The communications module 410 is a communication mechanism that allows the value engine 140 to communicate information and interconnect subsystems and devices. After the communications module 410 receives a vehicle's unique identifier, the source assessment module 420 triggers requests to appropriate sources in order to receive information for the value report. In certain cases, the source assessment module 420 only requests information if the vehicle's unique identifier originates from a dealer that is a subscriber to a vehicle history service (e.g., Carfax® or AutoCheck®), or participates in a third party certification program (e.g., Motor Trend® certification). In other situations, the source assessment module 420 either limits the query or filters the results (e.g., it may be desirable to only use DMS service history information of services performed in a certain date or odometer range so that only recent services are included). It may be useful for the source assessment module 420 to store some or all results in the value engine database component 340 so that repeated source requests for the same information can be avoided.

If appropriate, the source assessment module 420 will standardize the information. For example, inventory providers 310 might variously list a vehicle as having a “HDD Navigation System,” “Navigation Pkg” or simply “Navi.”

In each case, the source assessment module would identify the vehicle as having a navigation system. Similarly, different DMS 360 might code services differently such that one system might use “TBLS” while another might use “TB” to identify a timing belt replacement. In certain embodiments, not all information is required to be standardized. For example, although an inventory provider 310 might list a “cup holder” or a rear window defogger” as installed equipment or a DMS 360 might code services such as “head gasket replacement,” these types of information may not be recognized as a value attributes.

Once sources are queried and information is standardized the information is processed by the value logic module 430, which determines how the information is to be displayed. In a preferred embodiment the value logic module 430 sorts the information according to rank so that only the most relevant information is displayed in the value report. For example, new tires might be ranked higher than a 30,000 mile service, which might be higher than heated seats. Space or aesthetic considerations might dictate that the value logic module 430 only select a certain number of value factors to be displayed, preferentially selecting the highest ranked value factors.

Value logic module 430 might also be required to perform calculations in order to determine whether a value factor exists. For some value factors, such as third row seating, the vehicle either has the value factor or it doesn't. However, for other factors, such as whether it has low mileage for the model year or whether it is priced below average, require calculations. Yet other factors, such as whether it is a late model year or a popular color, could either be calculated by the value logic module 430, or identified in the standardization process of the source assessment module 420. For example, if a popular color determination was made across the entire industry, and all white, black, silver, grey and red colors were determined to be popular, then the source assessment module could simply filter out other colors. However, if a popular color determination was made based on dynamic market information, potentially including regional differences and categories of vehicles (such as vehicle editions, cars within a certain price range, or certain body types), then the source assessment module 420 would be more appropriate.

If the value report were to be used as a brochure, then negative attributes would not be displayed. In such an embodiment, it would be counter-productive to list missing value indicators (e.g., the specific vehicle did not have its scheduled 60,000 mile service, did not have a moon roof or was not priced below the market average). Similarly, in such an embodiment, only positive vehicle ratings and comments from the model & trim database 390 and only less attractive vehicles from the comp database 395 would be displayed. Furthermore, it might be advantageous to graphically display the value factors.

If the value features were to be used as advertising copy, then a comment builder 440 would be appropriate. Preferably, the comment builder 440 would be customizable so that dealer 130 would be able to personalize the comment builder 440. A comment builder 440 could use conditional segments and variables to create ad copy.

Conditional segments will typically only appear if a certain value factor is present. For example, “Just arrived!” might only print if the value engine 140 determines that the “new arrival” value factor applies. Similarly, “This car is priced below the market!” would only appear if the value engine 140 determines that “priced below average” value factor applies. However, other segments may be conditional based on other factors, such as year, make and/or model. For example, “Classic Buick muscle car!” might be conditioned on the vehicle being a 1984-1987 Buick Grand National. Not all segments must be conditional, and certain phrases or sentences might appear with all ad copy. For example, “We pride ourselves on exceeding all customer expectations! The next step? Give us a call to confirm availability.” might appear with every comment.

Variables can be used in segments to further customize messages. For example, instead of the segment being “This car is priced below the market!” if the “priced below average” value factor applies, the message could read “This [MODEL] will sell fast at this price!” where [MODEL] is a variable that is populated according to the specific vehicle being described.

Potential variables might include: [YEAR], [MAKE], [MODEL], [INTERNET.PRICE], [MSRP.PRICE.DIFFERENCE], [MILEAGE], [EXT.COLOR], [INT.COLOR], [TRIM], [ENGINE], [TRANSMISSION], [CHROME.AUTO.BRIEF.POSITIVE.REVIEW], [MPG.HWY], [MPG.CITY], [BODY], [MONTHLY.PAYMENT], [DEALER.NAME], [DEALER.ADDRESS], [DEALER.PHONE], [DEALER.WEBSITE], [GEN.MGR.FIRST.NAME], [GEN.MGR.LAST.NAME], [GEN.MGR.PHONE], [GEN.MGR.EMAIL], [INTERNET.MGR.FIRST.NAME], [INTERNET.MGR.LAST.NAME], [INTERNET.MGR.PHONE], [INTERNET.MGR.EMAIL], [USED.CAR.SALES.MGR.FIRST.NAME], [USED.CAR.SALES.MGR.LAST.NAME], [USED.CAR.SALES.MGR.PHONE], [USED.CAR.SALES.MGR.EMAIL], [VALUE.REPORT.BROCHURE.URL], [TOP.OPTION.VALUE.FEATURE], [TOP.3.OPTION.VALUE.FEATURES], [TOP.5.OPTION.VALUE.FEATURES], [TOP.10.OPTION.VALUE.FEATURES], [TOP.15.OPTION.VALUE.FEATURES], [TOP.20.OPTION.VALUE.FEATURES], [TOP.RECONDITIONING.VALUE.FEATURE], [TOP.3.RECONDITIONING.VALUE.FEATURES], [TOP.5.RECONDITIONING.VALUE.FEATURES], [TOP.10.RECONDITIONING.VALUE.FEATURES], [TOP.15.RECONDITIONING.VALUE.FEATURES], and [TOP.20.RECONDITIONING.VALUE.FEATURES].

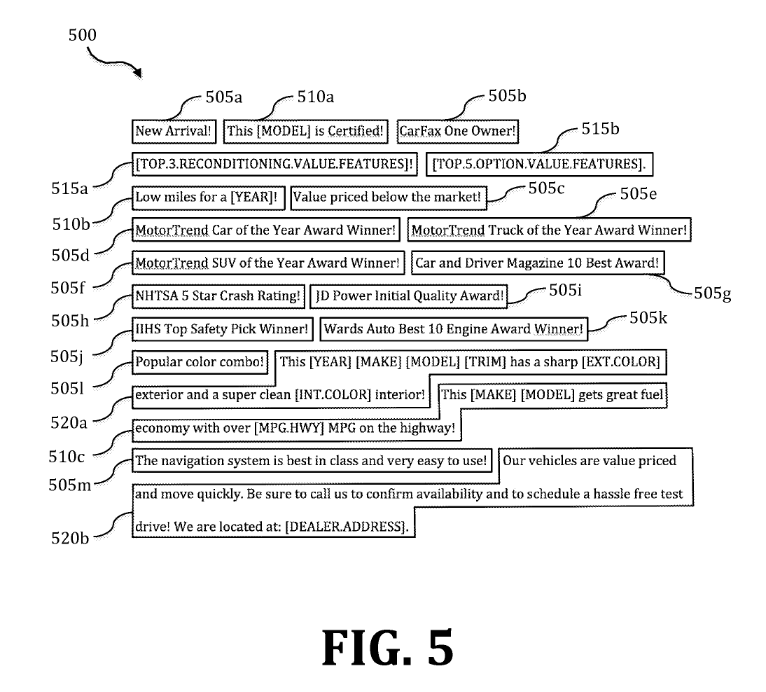

FIG. 5 is an exemplary comment 500 built with conditional segments 505, 510 and 515, non-conditional segments 520, and variables. Segment 505a is conditional on whether the value feature “new arrival” was present in the specific vehicle being evaluated. If it is, then the phrase “New Arrival!” (with capitalization and punctuation) would appear as the first sentence in the ad copy. Otherwise, the segment 505a simply would not appear in the final comment. Segments 505b-505m are similar to segment 505a, but are conditional on different value features. Specifically, segment 505b requires the “CARFAX 1-owner” value feature to exists for the vehicle for the segment 505b to appear, segment 505c requires “priced below average,” segment 505d requires “Motor Trend car award,” segment 505e requires “Motor Trend truck award,” segment 505f requires “Motor Trend SUV award,” segment 505g requires “Car and Driver 10 best,” segment 505h requires, “NHTSA 5-star rating,” segment 505i requires “JD power quality award,” segment 505j requires “IIHS top safety pick,” segment 505k requires “Ward's 10 best engines,” segment 505l requires “in demand color,” and segment 505m requires “navigation system.” It should be appreciated that, except for simple conditional segment 505m, each simple conditional segment 505a-505l, was described above as being part of the catch-all “Other” category. In the described embodiment, there is no variable for this category (e.g., there is no [TOP.3.OTHER.VALUE.FEATURES] variable). Therefore, in order to have one of these value features appear in the ad copy, appropriate copy must be written as a conditional segment. This provides maximum flexibility in both arranging the value features (e.g., “priced below average” does not need to appear first) and in messaging (e.g., “Value priced to be below the market average!” might be better ad copy).

Segment 510a is conditional on whether the value feature “certified vehicle” was present in the specific vehicle. Furthermore, since segment 510 includes the variable [MODEL], other particulars about the specific vehicle need to be resolved. For example, if the specific vehicle was a 2004 Ford Thunderbird with a silver exterior and black interior that gets 23 miles per gallon on the highway, then the [MODEL] variable would be “Thunderbird.” [YEAR] would be “2004,” [MAKE] would be “Ford,” [EXT.COLOR] would be “silver,” [INT.COLOR] would be “black” and [MPG.HWY] would be “23.” Capitalization of the various variables can either be set by rules (e.g., [MODEL] is always capitalized and [INT.COLOR] is always lower case) or can be customizable. Therefore, if the “certified vehicle” value feature were present for the specific vehicle, then the segment 510a would print as “This Thunderbird is certified!” However, if the “certified vehicle” value feature were absent, then the entire segment would not be displayed. Similarly, segment 510b requires the “low miles” value factor in order to display “Low miles for a 2004!” and segment 510c requires the “fuel efficient” value factor. Since value engine 140 would not recognize a car with 23 mpg as a fuel-efficient vehicle, the value factor “fuel efficient” would not exist for the Thunderbird example, and segment 510c (“This Ford Thunderbird gets great fuel economy with over 23 MPG on the highway”) would not appear in the ad copy.

Segments 515a and 515b have variables that use the categorization of value features as a shortcut. Although other segments 505 and 510 are conditional on particular value features, segments 515a and 515b group many value features together, using the reconditioning and option value feature categories. In such an embodiment, the value feature categories are preferably ranked so that the variable [TOP.3.RECONDITIONING.VALUE.FEATURES] in segment 515a can identify the three highest ranked reconditioning value features that exist for the particular vehicle. The variable can be programmed so that it is presented is proper grammatical form (with commas separating each value feature and an “and” preceding the last value feature in the list). Additionally, if less than three value features were present, then the variable could be programmed to properly display in those scenarios (e.g., no “and” is used if there is only one value feature). For simplicity, the text that is printed for the [TOP.3.RECONDITIONING.VALUE.FEATURES] variable can be the same as the appropriate value features. Therefore, if the value engine 140 determined that the specific vehicle had the value factors of “60 k service performed,” “vehicle detailed,” “new brakes,” and “timing belt replaced,” then segment 515a might display as “New brakes, 60 k service performed, and timing belt replaced!” (the three highest ranked reconditioning value features, in order, with appropriate grammar and ending in an explanation point).

As depicted, segment 515a is conditional on at least one reconditioning value option being present. Otherwise, the ending exclamation point would appear without any value features preceding it. Alternatively, ending punctuation could be programmed into the variable itself so that an empty set would result in nothing being printed.

Segment 515b would work in a similar way, but using option value features. It should be appreciated that if the specific vehicle had the “navigation system” value feature then, because it is the top ranked value feature in the option value feature category, “navigation system” would be mentioned in both segment 515b and segment 505m. In segment 515b, it would appear as “Navigation system, entertainment system, satellite radio, and chrome wheels” if those were the top 4 features available for that specific vehicle and there was no fifth value feature. In simple conditional segment 505m, the text would always appear as “The navigation system is best in class and very easy to use!” if the specific vehicle had the navigation system value feature.

Segments 520a and 520b are not conditional and will always appear in the comment 500. For the exemplary specific vehicle, segment 520a would be “This 2004 Ford Thunderbird has a sharp silver exterior and a super clean black interior!” Since the 2004 Ford Thunderbird had only a single trim level, the [TRIM] variable would either be empty or have a generic description such as “convertible 2D.” Once the comment is constructed, the finished comment could be delivered to the dealer 130, or to listing sites 150, or both, as described in step 285 in FIG. 2B.

Many usability enhancements are possible to make customization of comment 500 easy and intuitive. For example, conditional segments 505, 510 and 515, non-conditional segments 520 could be colored differently to make it easy for a user to recognize one from the other. The user interface might allow segments 505, 510, 515 and 520 to be dragged and dropped to quickly reorder the segments. Formatting and capitalization of variable text might be tied to the formatting of the variable (e.g., a [Model] might return “Thunderbird,” while [MODEL] returns “THUNDERBIRD”). Multiple comments 500 with different segment wording and segment order might be used so that a dealer's inventory would not use the same format for each vehicle, giving the dealer's inventory more variety. An enhancement for delivering the output of comment builder 440 to the dealer 130, or to listing sites 150, or both (step 285 of FIG. 2B), might be to allow the dealer 130 to manually edit the output and to highlight potential errors for the dealer to review.

Those skilled in the art will readily appreciate that although the description of FIG. 4 and FIG. 5 describe a comment engine and text segments, the identical structure and methodology would be appropriate for a more generic media engine that integrates not only textual segments, but media segments that can include audio, video and/or graphics.

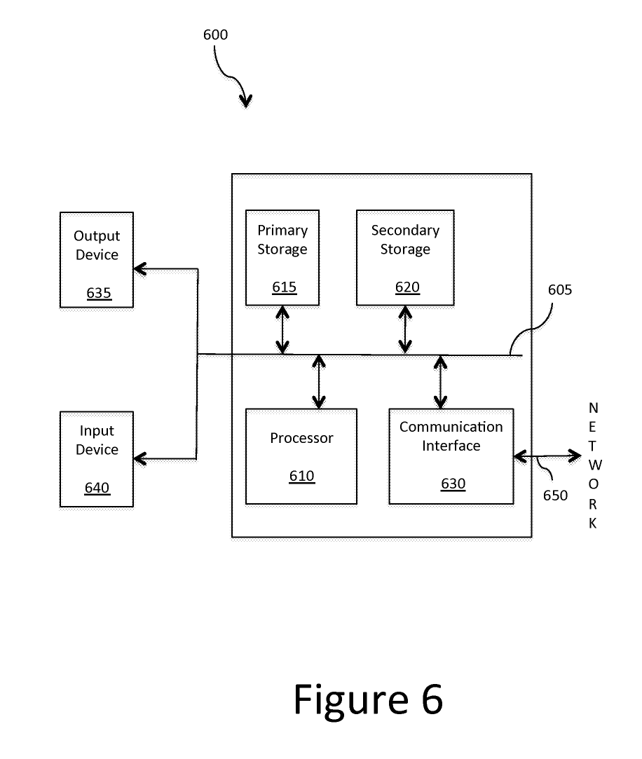

FIG. 6 illustrates an exemplary computer system 600 suitable for carrying out certain functions described herein. In some examples, computer system 600 may be used to implement computer programs, applications, methods, processes, or other software to perform the above-described techniques. Computer system 600 includes a bus 605 or other communication mechanism for communicating information, which interconnects subsystems and devices, such as processor 610, primary storage 615 that is directly accessible by the processor 610 (e.g., registers, cache, and RAM), secondary storage 620 that is not directly accessible by the processor 610 (e.g., HDD, SSD, and removable media), communication interface 630 (e.g., modem or Ethernet card), display 635 (e.g., CRT, LCD or other output devices), and input device 640 (e.g., keyboard, mouse or touchpad).

According to some examples, computer system 600 performs specific operations by processor 610 executing one or more sequences of one or more instructions placed in primary storage 615. Such instructions may be read into system memory 615 from another computer readable medium, such as disk drives (magnetic or optical), electronic (flash or EEPROM), or other forms of storage. In some examples, hard-wired circuitry may be used in place of or in combination with software instructions for implementation.

The term “computer readable medium” refers to any tangible medium that participates in providing instructions to processor 610 for execution. Such a medium may take many forms, including but not limited to, non-volatile media and volatile media. Non-volatile media includes, for example, optical, magnetic, or solid-state drives. Volatile media includes dynamic memory, such as RAM. In some examples, a single apparatus (i.e., device, machine, system, or the like) may include multiple types of media (e.g., a drive with both solid state and disk components). In other examples, multiple disparate storage facilities in different apparatus may be used. Further, the techniques described herein may be used with any type of digital memory without limitation or restriction. The described techniques may be varied and are not limited to the examples or descriptions provided.

Common forms of computer readable media includes, for example, floppy disk, flexible disk, hard disk, magnetic tape, any other magnetic medium, CD-ROM, any other optical medium, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 605 for transmitting a computer data signal.

In some examples, execution of the sequences of instructions may be performed by a single computer system 600 and in others, two or more computer systems 600 coupled by communication link 650 (e.g., LAN, PSTN, or wireless network) may perform the sequence of instructions in coordination with one another. Computer system 600 may transmit and receive messages, data, and instructions, including program, i.e., application code, through communication link 650 and communication interface 630. Received program code may be executed by processor 610 as it is received, and/or stored for later execution.

As previously stated, detailed embodiments of the present invention are disclosed herein; however, it is to be understood that the disclosed embodiments are merely exemplary of the invention that may be embodied in various forms. It will be appreciated that many modifications and other variations stand within the intended scope of this invention as claimed below. For example, although comments are described as text, other media such as audio and/or video could also be used in a similar manner. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

Accordingly, that which is intended to be protected by Letters Patent is set forth in the claims and includes all variations and modifications that fall within the spirit and scope of the claim. Notwithstanding the foregoing, the claims described in the Letters Patent have been presented with the intent of avoiding the construction authorized under 35 USC §112(f). Specifically, regardless of whether a claim has functional language, the scope of such a claim is not intended to, in the words of 25 USC §112(f), “cover the corresponding structure, material, or acts described in the specification and equivalents thereof.” If necessary, and as long as the result is not invalidity, a claim should be interpreted (which may include disregarding formatting such as line indentations) such that either (i) it is not for a combination or (ii) functional elements encompass structure, material, or acts in support thereof.

What is claimed:

1. A comment engine for a particular vehicle comprising:
a communications module that transmits and receives information, including vehicle inventory from an external inventory provider, wherein the vehicle inventory includes the particular vehicle;
a source assessment module that receives information from a plurality of third party sources regarding the particular vehicle and standardizes the information received as features for the particular vehicle;
a value logic module that examines the features and determines if the features are associated with highlights, wherein the highlights are ranked and categorized;
a comment builder that creates content for the particular vehicles, utilizing conditional media segments that are included only if certain highlights are present for the particular vehicle and utilizing variables within the media segments that are dependent on features of the particular vehicle, wherein the content does not include any indication that non-present highlights are absent and wherein the included media segments are relevant to the present highlights.

2. The comment engine of claim 1, wherein the source assessment module receives information from at least one third party source regarding the vehicle edition of the particular vehicle.

3. The comment engine of claim 1, wherein the plurality of third party sources includes an inventory provider and a VIN decoder.

4. The comment engine of claim 1, wherein the comment builder utilizes variables within the media segments that are dependent on highlights of the particular vehicle.

5. The comment engine of claim 4, wherein
each highlight has a textual description, and
some media segments that are dependent on highlights are composed primarily of the textual descriptions.

6. The comment engine of claim 1, wherein the value logic module performs calculations on at least one feature to determine whether such feature qualifies as a highlight.

7. The comment engine of claim 6, wherein the calculations include a determination of whether the particular vehicle's advertised price is lower than an average price for the vehicle edition of the particular vehicle.

8. The comment engine of claim 6, wherein
a feature includes a model year, and
the calculations include a determination of whether the particular vehicle's mileage is lower than a pre-determined mileage for the particular vehicle's model year.

9. The comment engine of claim 1, wherein the comment builder utilizes conditional media segments that are included only if a highlight within a certain category is present for the particular vehicle.

10. The comment engine of claim 1, wherein the comment builder utilizes additional conditional media segments that are included only if a highlight within a certain category is present for the particular vehicle such that the additional included media segments are relevant to the highest-ranked highlight within the certain category.

11. The comment engine of claim 1, wherein the comment builder utilizes additional conditional media segments that are included only if highlights within a certain category are present for the particular vehicle such that the additional included media segments are relevant to a predetermined number of the highest-ranked highlights within the certain category.

12. A media engine for a particular vehicle comprising:
a source assessment module that receives information from a plurality of third party sources regarding the particular vehicle, including vehicle inventory from an inventory provider, and standardizes the information received as features for the particular vehicle;
a value logic module that examines the features and determines if the features are associated with highlights;
a media builder that creates content for the particular vehicles, utilizing conditional media segments that are included only if certain highlights are present for the particular vehicle and utilizing variables within the media segments that are dependent on features of the particular vehicle, wherein the content does not include any indication that non-present highlights are absent and wherein the media segments are relevant to the present highlights.

13. The media engine of claim 12, wherein the source assessment module receives information from at least one third party source regarding the vehicle edition of the particular vehicle.

14. The media engine of claim 12, wherein the comment builder utilizes variables within the media segments that are dependent on highlights of the particular vehicle.

15. The media engine of claim 12, wherein the value logic module performs calculations on at least one feature to determine whether such feature qualifies as a highlight.

16. The media engine of claim 12, wherein the comment builder utilizes conditional media segments that are included only if a highlight within a certain category is present for the particular vehicle.

17. The media engine of claim 12, wherein the comment builder utilizes additional conditional media segments that are included only if a highlight within a certain category is present for the particular vehicle such that the additional included media segments are relevant to the highest-ranked highlight within the certain category.

18. The comment engine of claim 12, wherein the comment builder utilizes additional conditional media segments that are included only if highlights within a certain category are present for the particular vehicle such that the additional included media segments are relevant to a predetermined number of the highest-ranked highlights within the certain category.

19. A comment engine for a particular vehicle comprising:
a source assessment module that receives information from a plurality of third party sources regarding the particular vehicle, including vehicle inventory from an inventory provider, and standardizes the information received as features for the particular vehicle;
a value logic module that examines the features and determines if the features are associated with highlights;
a comment builder that creates content for the particular vehicles, utilizing conditional segments that are included only if certain highlights are present for the particular vehicle and utilizing variables within the segments that are dependent on features of the particular vehicle, wherein the content does not include any indication that non-present highlights are absent and wherein the segments are relevant to the present highlights.
